(19) United States
(12) Patent Application Publication
(10) Pub. No.: US 2004/0267693 A1
(43) Pub. Date: Dec. 30, 2004

(54) Method and system for evaluating the suitability of metadata

(76) Inventors: Darryn Lowe, Botany (AU); Ricardo Gandia, Sutherland (AU)

Correspondence Address: Jonathan P. Meyer, MOTOROLA, INC., 1303 East Algonquin Road, Schaumburg, IL, 60196, US

(21) Appl. No.: 10/609,856

(22) Filed: Jun. 30, 2003

(51) Int. Cl. G06F 7/00

(52) U.S. Cl. 707/1

(57) ABSTRACT

The present invention provides a method and system (113) for evaluating the suitability of metadata for an item, which is to be archived in a computer readable memory (101). The metadata values annotated to the item are evaluated and a suitability indication (501,503,505) is provided to a user. The suitability indication is provided based on the comparison of actual number of occurrences of the annotated metadata values in the computer readable memory and the number of occurrences desired by the user. The desired number of occurrences is determined on the basis of past searching habits of the user. The suitability indication comprises an individual suitability (501), a union suitability (503) and a combined suitability (505).

### FIELD OF THE INVENTION

The present invention relates to the field of information retrieval systems. More specifically, the present invention provides a method and system for evaluating the suitability of metadata for an item.

### BACKGROUND OF THE INVENTION

Over the last decade, there has been a huge growth in the Internet and various other networks. This growth has enabled easy sharing and downloading of data from various information sources. The data referred to here may be text documents or media content. At the same time, there has been an increase in usage of electronic data and electronic documents have become an alternative to traditional paper documents. Further, analog media content has become available in digital format. For instance, images are now available in JPEG, GIF formats, audio files in mp3 format, and waveform files and video files in MPEG formats.

This popularity of electronic data and its easy availability has led to a tremendous increase in the amount of electronic data stored in various databases. Consequently, it is becoming difficult for a user to retrieve data in an efficient manner. Moreover, the number of data files in the databases have increased so much that it is quite possible that a large number of files are of similar nature. As a result, it is not easy for the user to identify a particular file of his/her interest. For example, if a user has a large collection of songs by a popular artist, then it is difficult for him to choose a particular song by just looking at the large collection.

Though there are search utilities available that facilitate the retrieval of data from databases, the number of search results returned by these search utilities can be unnecessarily large. Also, a considerable amount of these search results are irrelevant to the user. These search utilities search for a given data file by referring to metadata associated with the data file. The metadata referred to here is textual information attached to the data file. This textual information very briefly describes the data file. For example, in case of video files, the metadata associated with the video file may be title of the video, length of the video, artists in the video etc.

The efficiency of a search in a database depends upon the suitability of the metadata associated with the data files in the database. A metadata is of suitable quality if it is relevant to the data file and describes the data file sufficiently when compared to other metadata in the database. The metadata for a data file can be generated automatically by the system or provided by a user.

In case of text documents, the system can browse through the document and generate the metadata automatically. However, in case of media content, it is not feasible for the system to browse through the media content. Various methods and systems have been proposed for generating the metadata automatically for the media content. One such method is based upon the similarity between an acquired image and one or more images that are maintained in an image database environment. The stored images have pre-existing captions or labels associated with them. The caption or label for the acquired image is generated from the pre-existing captions or labels associated with the similar stored images.

In case of the text documents, since the system extracts the metadata by browsing through a document, a suitable quality metadata can be generated. In most of the cases, this metadata is a true reflection of the content of the document. However, in case of media content, it is difficult to extract relevant and sufficient metadata for an item (a media file) automatically. Accordingly, most often the user annotates the metadata manually in case of media content and the user should annotate the items such that the metadata is relevant and sufficient for the item. However, to describe the item sufficiently, the user may have to remember or recall the metadata associated with the existing collection of items stored in the database. This is because the sufficiency of metadata will depend upon the user's existing collection of items. For example, if a user has to annotate a picture of a bull dog in his collection of pictures, then he may provide “dog” as the title of the image. However, if the user's collection of images already contains many pictures of dogs, then a title such as “bull dog” will be more suitable. This title will help the user to retrieve this picture easily in his future searches. However, with the increase in size of the user's collections, it Will be difficult for him to recall the full extent of his collection, and hence annotate an item with suitable quality metadata.

Various methods have been proposed for improving the quality of metadata associated with the items. One such method includes analysis of each field of the URL of the multimedia and streaming media. Each field is analyzed to identify new metadata associated with that field. The identified new metadata is added to the original metadata.

Another such method includes separating the metadata into keywords. The keywords are compared with valid keywords. A score is calculated in accordance with the degree of similarity between the keywords and the valid keywords. If the degree of similarity is above a threshold, the metadata is qualified as valid metadata. Valid metadata is available for comparison and correction of invalid metadata.

However, the above methods suffer from one or more of the limitations mentioned hereinafter. These methods do not provide evaluation of metadata, based on which the user may conclude whether the metadata annotated by him/her is suitable enough to facilitate efficient retrieval of the item in future searches. Moreover, the above mentioned methods for metadata quality improvement do not take into consideration the searching habits of the user. A user searching the database may have certain searching habits. For example, a user may have a habit of searching items using the “title” field. In that case, it may not be a good idea to improve the quality of metadata for the “subject” field. Therefore, it is important that the method for improving the metadata for an item takes into consideration the past searching habits of the user.

In the light of above discussion, there is need for a method and system that evaluates the metadata and hence suggest its suitability.

### SUMMARY OF THE INVENTION

The present invention is directed towards a method and system for evaluating the suitability of metadata for an item, which is to be archived in a computer readable memory.

The system for the present invention comprises a metadata suitability evaluator and a user interface. The metadata suitability evaluator evaluates the suitability of metadata values for an item. The user interface allows the user to provide metadata values to the metadata suitability evaluator. The user interface also displays the suitability evaluation results, generated by metadata suitability evaluator, to the user.

In accordance with a preferred embodiment of the present invention, the metadata suitability evaluator first obtains the metadata values. The metadata values may be either provided by a user or generated automatically. After obtaining the metadata values, the metadata suitability evaluator determines actual number of occurrences of the metadata values in the computer readable memory. Thereafter, the metadata suitability evaluator determines the number of occurrences desired by the user. The desired number of occurrences is determined on the basis of the user's past searching habits. The actual number and desired number of occurrences are compared to provide a suitability indication for the metadata values to the user. The suitability indication is displayed to the user on the user interface.

The suitability indication may be in the form of an individual suitability, a union suitability and a combined suitability. The individual suitability indicates the suitability of each metadata value while union suitability indicates the suitability for a combination of two or more metadata values. The combined suitability represents the suitability for a combination of all the metadata values.

In an alternative embodiment of the present invention, the suitability indication is provided only on the basis of actual number of occurrences of the metadata values.

Another embodiment of the present invention provides a method and system for annotating an item with a suitable metadata. In this embodiment, the system evaluates the metadata annotated automatically or by a user. Based on the suitability indication, if the user feels that the metadata values are not suitable, he/she may revise them. The system then evaluates the suitability of revised metadata values. If the user still feels, based on the evaluation results, that even the revised metadata values are not suitable, he/she may revise the metadata values again. This process of revising and evaluating the metadata may be repeated until the user feels that the metadata values are suitable.

### BRIEF DESCRIPTION OF THE DRAWINGS

The preferred embodiments of the invention will hereinafter be described in conjunction with the appended drawings provided to illustrate and not to limit the invention, wherein like designations denote like elements, and in which:

FIG. 1 illustrates an exemplary environment for the working of the present invention;

FIG. 2 illustrates the components of a metadata evaluation system in accordance with a preferred embodiment of the invention;

FIG. 3 illustrates the method for evaluating the suitability of metadata for an item in accordance with a preferred embodiment of the present invention;

FIG. 4 illustrates graphical view of an exemplary function for calculating the individual suitability of metadata;

FIG. 5 illustrates an exemplary user interface that displays the suitability indication for the metadata values of an item;

FIG. 6 shows a table of results generated by metadata suitability evaluator in accordance with an example;

FIG. 7 illustrates the method for evaluating the suitability of metadata for an item in accordance with an alternative embodiment of the present invention; and

FIG. 8 illustrates the method of annotating an item with a suitable metadata in accordance with an alternative embodiment of the present invention.

### DETAILED DESCRIPTION OF PREFERRED EMBODIMENT OF THE INVENTION

For convenience, terms that have been used in the description of preferred embodiments are defined below. It is to be noted that these definitions are given merely to aid the understanding of the description, and that they are, in no way, to be construed as limiting the scope of the invention.

Definitions

Item: An item in the present invention refers to a data file containing media content. Examples of the item may be a video file, an audio file or an image.

Metadata: Metadata refers to textual information attached to the item. This textual information briefly describes the item. For example, if there is an audio file for a song, then the metadata associated with the audio file may contain information about the song such as title, artist, genre etc. The metadata for each item contains a set of metadata fields and a corresponding set of metadata values. For example, the metadata fields for an audio file may be “title”, “artist” and “item format” etc., while the corresponding metadata values for the audio file may be “Its my life”, “Bon Jovi” and “mp3”. It should be apparent to one skilled in the art that the metadata fields may be explicitly or implicitly defined. For example, a file named “mountain picture” defines the metadata values “mountain” and “picture” as belonging to a metadata field, such as “item name”, that is implicitly defined by the context of the metadata value.

Metadata Fields (F): Metadata fields, denoted by F, define the type of information to be associated with the item. For example, if there is a video file, then the metadata fields for the item may be “Name of the video”, “duration of the video”, “artists in the video” etc. The metadata fields may be generic or specific to an item. For example, “name of the item” is a generic field. The name can be associated with any type of item. However, “lyrics of the song” is specific to audio files.

Metadata Values (V): Metadata values, denoted by V, are a set of keywords that provide information about the item. The metadata values correspond to the metadata fields. For example, if the metadata field for an audio file is “genre”, then the metadata value corresponding to the field may be “rock music”. The metadata values for the item may be generated automatically or they may be provided by a user. For example, if the item is a song file then the metadata value corresponding to “file format” may be automatically generated by the system. However, the metadata value corresponding to “name of the artist” may be provided by the user.

Frequency of previous search (n(F)): Frequency of previous search, denoted by n(F), defines the number of times a search has been performed on a metadata field F in the past. For example, if the frequency of previous search for the “title” field is 100, then it implies that the “title” field has been searched 100 times by a user in the past.

Actual number of occurrences for a metadata value (r(F∩V)): Actual number of occurrences for a metadata value V corresponding to a field F, denoted by r(F∩V), represents the number of occurrences of the proposed metadata value V in the existing collection of items. In other words, r(F∩V) denotes the number of occurrences returned by a search query based on (F∩V). For example, if a user has annotated an image file by giving “mountain” as the title, then a value of 70 for r(F₁∩V₁) would indicate that “mountain” occurs 70 times in the “title” fields of existing items. Here F₁ refers to “title” and V₁ refers to “mountain.

Desired number of occurrences for a metadata field (r(F)): Desired number of occurrences for a metadata field, denoted by r(F), indicates the number of results desired by a user for search on a particular field. The user expects different numbers of results from searches on different fields. These expected numbers could be inserted by a user or they could be defaults. For example, the user could expect more results when performing a search on the “subject” field as opposed to the “title” field. Moreover, different users could desire a different number of results from a particular search based on what that they find a manageable quantity.

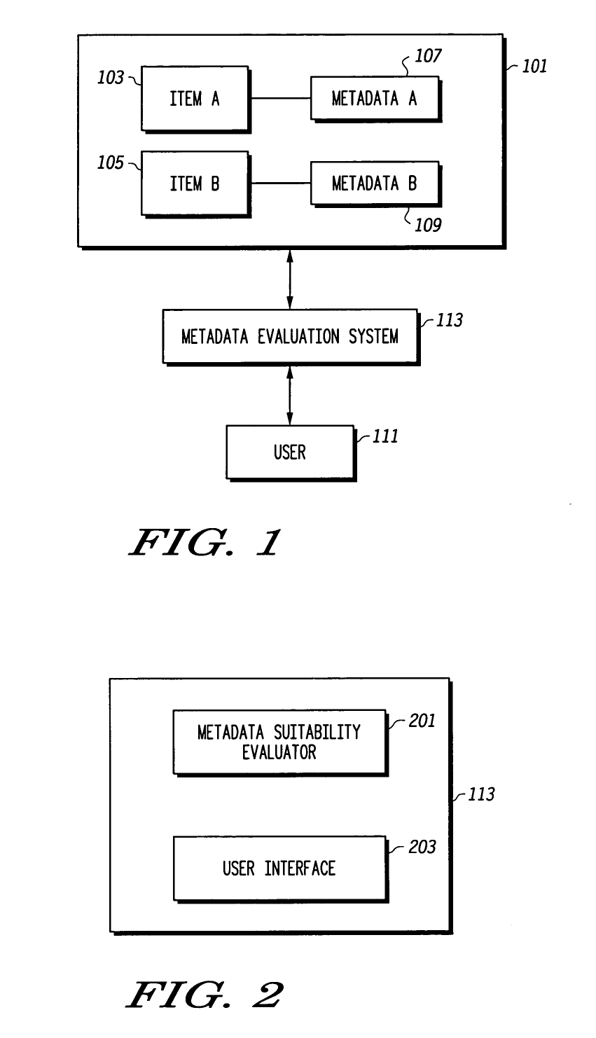

The present invention provides a method and system for evaluating the suitability of metadata for an item, which is to be archived in a computer readable memory. The suitability evaluation can indicate to the user whether the metadata for the item is suitable enough to facilitate efficient retrieval of the item in future searches. If the user feels that the metadata is not suitable, he/she may either modify the metadata or provide more metadata. FIG. 1 illustrates an exemplary environment for the working of the present invention. A computer readable memory 101 has various items archived. Each item has associated metadata. As shown in FIG. 1, computer readable memory 101 contains an item A 103 and an item B 105. Item A 103 has associated metadata A 107. Similarly, item B 105 has associated metadata B 109. Besides the items and the metadata, computer readable memory 101 may also comprise a record of the user's past searching habits. A user 111 uses a metadata evaluation system 113 for evaluating the metadata for items in computer readable memory 101.

An example of computer readable memory 101 may be a database. The database may employ standard database management systems (DBMS) such as IBM® DB2/Common-Server, Sybase®, and Oracle® etc for storage of items, metadata and a record of the user's past searching habits.

FIG. 2 illustrates the components of the metadata evaluation system 113 in accordance with a preferred embodiment of the invention. Metadata evaluation system 113 comprises of a metadata suitability evaluator 201 and a user interface 203.

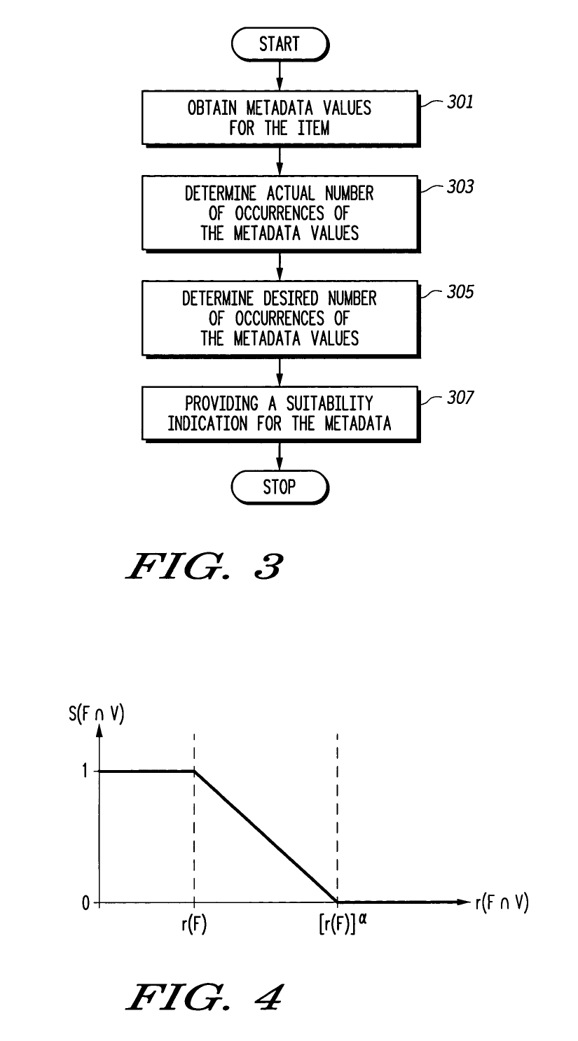

Metadata suitability evaluator 201 evaluates the suitability of metadata values for an item. The inputs to metadata suitability evaluator are the metadata values for the item. These metadata values may either be provided by a user or generated by a system that has the functionality of generating the metadata automatically. The output of metadata suitability evaluator 201 is a suitability indication that is displayed to the user. The exact manner in which the metadata values are evaluated has been explained in detail in conjunction with FIG. 3.

User interface 203 allows a user to provide metadata values, which are then evaluated by metadata suitability evaluator 201. User interface 203 also displays the suitability indication, generated by metadata suitability evaluator 201, to the user. This suitability indication may be displayed in various user-friendly formats such as bar graphs and pie charts. An exemplary user interface has been illustrated and described later in conjunction with FIG. 5.

FIG. 3 illustrates the method for evaluating the suitability of metadata for an item in accordance with a preferred embodiment of the present invention. As shown in FIG. 3, metadata suitability evaluator 201 obtains metadata values for an item at step 301. The metadata values may be provided by a user manually or may be generated by a system automatically. For example, if the item is an audio file, then “name of the artist” for the audio file may be provided by the user while the “item format” may be generated automatically by the system having such functionality. After the metadata values have been obtained, actual number of occurrences (r(F∩V)) for metadata values is determined, as shown at step 303.

The actual number of occurrences r(F∩V) may be determined in a manner described hereinafter. A search query using (F∩V) as the search criterion is constructed. Thereafter, computer readable memory 101 is searched with the constructed search query. The number of results returned by the search query is equal to the r(F∩V). In other words,

r(F∩V)=Number of results from search query based on (F∩V)

At step 305, the desired number of occurrences r(F) for metadata fields, corresponding to the metadata values, is determined. There are several mechanisms by which r(F) can be determined. One approach could be to have a fixed number of results (such as for a device like a PDA with a limited display). The user may also provide the desired number of occurrences manually. Alternatively, a dynamic approach could be used, such as the one defined by the following function:

r(F)=Average number of results from queries based on F

There can be many approaches by which this average could be obtained. One such approach for calculating this average has been explained hereinafter. The first step is to identify past successful searches for the field corresponding to the metadata value. Thereafter, obtain an average of number of search results returned by these past successful searches. The past successful searches are the searches that were not cancelled by the user within a predefined time after the completion of the searches.

At step 307, metadata suitability evaluator 201 provides the suitability indication for the metadata values. The suitability indication is based on the comparison of r(F∩V) and r(F) values. The suitability indication may be in the form of an individual suitability (I), a union suitability (U) and a combined suitability (S).

Individual suitability, denoted by I, indicates the suitability of each proposed metadata value individually. For example, if a user has supplied “Cat”, “Red”, “3 years” as the metadata values for a picture of cat, then I(Cat) would indicate the suitability of “Cat” only. Similarly, I(Red) and I(3 years) would indicate the suitabilities of “red” and “3 years” individually.

Union suitability, denoted by U, indicates the suitability of a combination of two of more metadata values. Referring to the example given for the individual suitability, U(Cat, Red) would indicate the combined suitability for two metadata values (Cat and Red).

Combined suitability, denoted by C, represents the combined suitability of all the metadata values for an item. Referring to the example given for the individual suitability, C(Cat, Red, 3 years) would indicate the combined suitability of all the three metadata values.

It should be apparent to one skilled in the art that the suitability indication may be represented in various forms. The forms of suitability explained in the present invention are for exemplary purposes only. Any other form of suitability indication can also be determined by comparing the r(F∩V) and r(F) values.

A method for determining the individual suitability (I) is explained hereinafter in conjunction with FIG. 4. The individual suitability I may be indicated on a scale of 0 to 1, with 1 being completely suitable and 0 being unsuitable. If the r(F∩V) value is less than or equal to the r(F) value, then the metadata value is completely suitable and the individual suitability I is equal to 1. When the r(F∩V) value exceeds the r(F) value, the individual suitability I drops until the proposed metadata is considered vague or unsuitable. There is a critical point at which the metadata value is entirely unsuitable. This critical point may be defined as being the desired number of results raised to the power of a constant α. At this critical point, the metadata value is considered unsuitable and the value of the individual suitability I is 0. The interpolation between 0 and 1 may be linear as shown. The mathematical function for calculating the individual suitability may be summarized as:

I=1, if 1<=r(F∩V)<=r(F);

I=[{r(F)}^{α}−r(F∩V)]/[{r(F)}^{α}−r(F)], if r(F)<=r(F∩V)<={r(F)}^{α};

and

I=0, if r(F∩V)>{r(F)}^{α}.

The constant α simply sets the “sensitivity” as to what defines “suitable” or “unsuitable” metadata. For example, a high α would mean that metadata evaluation system 113 would say that the metadata was “suitable” even if many more occurrences of metadata value than expected were returned. Conversely, a low α means that metadata evaluation system 113 would flag that the metadata value is unsuitable even if a few more occurrences than expected were returned.

The actual value of α can be defined either by the system provider or by the user. The former case is the simpler one and may be sufficient in many instances. The latter case could be used by the user if he/she feels that the system's sensitivity is either excessive or insufficient.

It should be apparent to one skilled in the art that the method described herein for calculating I is exemplary. Any monotonic inversely proportional relationship may be used for calculating the individual suitability I i.e. as the actual number of occurrences exceeds the desired number of occurrences, the individual suitability should decline.

The union suitability (U) may also be determined in a manner similar to the calculation of I. In the calculation of U, r(F∩V) is replaced by r{r(F₁∩V₁)∩(F₂∩V₂)} and r(F) would be replaced by r(F₁ ∩F₂) for a combination of two metadata values V₁ and V₂. Similar expressions can be derived for a combination of three or more metadata values. Also, U is calculated only for a valid combination of two or more metadata values. A valid combination is a combination of metadata values, for which the value of desired number of occurrences for the combination of metadata fields (corresponding to the metadata values) is greater than 0. In other words, the user must have performed at least one search on the combination of fields. The fields here correspond to the metadata values for which the union suitability is being calculated. For example, if an item has metadata values V₁, V₂, V₃ and V₄, then V₂ and V₃ will be a valid combination if the user has performed at least one search on a combination of corresponding fields, F₂ and F₃.

The method for calculating the combined suitability C is described hereinafter. As C is an indication of the suitability for a combination of all the metadata values, it can be derived using the individual suitability values for the metadata values. Various mathematical approaches may be used that combine the individual suitabilities and determine the value of C. One such approach uses a weighted average based on the frequency of previous searches n(F) and the corresponding individual suitabilities I(F∩V). In accordance with this approach, C may be expressed as:

C=[Σn(F)*I(F∩V)]/Σn(F)

This mathematical function for calculating C takes into consideration that a user relies on some fields more than others while identifying an item. For example, if a user relies more on “title” field while searching for items, then n(F) for that field is high and is reflected in the combined suitability calculation.

In case there are valid combinations of metadata values, then the union suitabilities may be included in the calculation of C. The values of U can be included by taking their weighted average based on the frequency of previous searches performed on the combination of fields.

FIG. 5 illustrates an exemplary user interface that displays the suitability indication for the metadata values of an item. The user interface displays bar graphs 501 for the individual suitability, a bar graph 503 for the union suitability and a bar graph 505 for the combined suitability. The user interface also displays a thumbnail 507 of the item, for which the metadata values are evaluated.

It should be apparent to one skilled in the art that the present invention may also be used to evaluate the suitability of metadata for a mixed set of data files. The data files may either be items (defined as media content in the present invention) or any form of text files.

Having described the general method for evaluating the suitability of metadata in accordance with the preferred embodiment of the present invention, an example for evaluating the suitability of metadata for a collection of pictures has been described hereinafter.

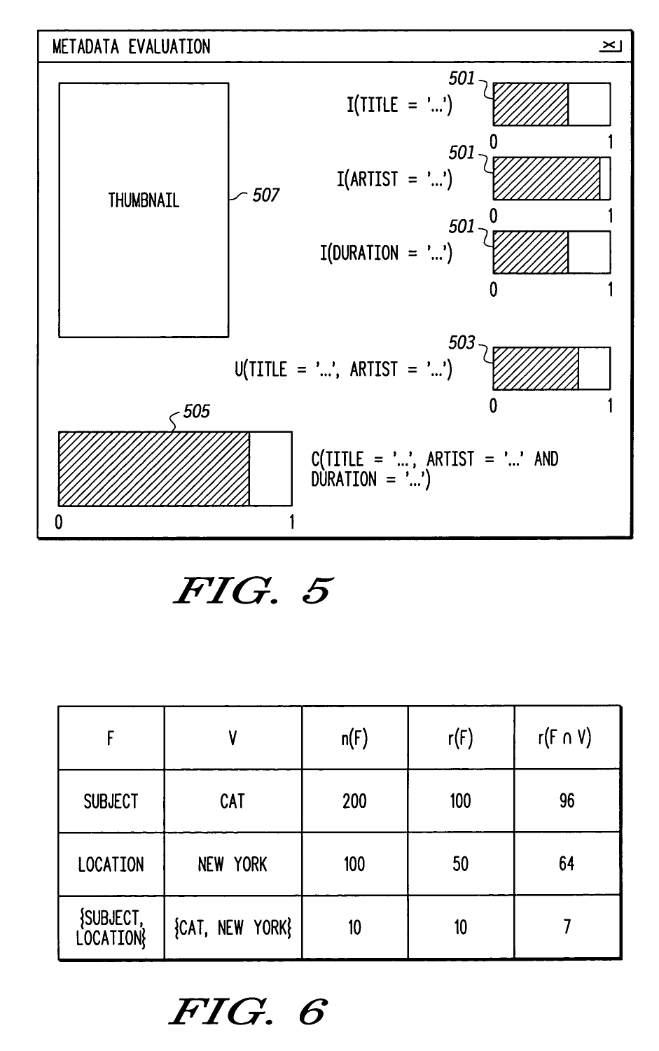

Consider that a user has a collection of 500 items in the form of pictures stored in a database on the memory 101. The fields associated with each picture are “subject” and “location”. Now, the user annotates a new picture of a cat with “cat” as the subject and “New York” as the location using user interface 203. Metadata suitability evaluator 201 searches the user's collection of items and the record of the user's past searches in computer readable memory 101. The results generated by metadata suitability evaluator 201 are summarized in FIG. 6.

Metadata suitability evaluator 201 determines the values of I, U and C using these results. Assuming the value of α is 1.5, the calculation of I, U and C is shown as follows:

I(Cat)=1, since r(F∩V) for “Cat” is less than r(F);

Since r(F)<r(F∩V)<{r(F)} for “New York”, I(New York) is calculated as:

I(New York)=[{50}^{1.5}−64]/[{50}^{1.5}−50]

I(New York)=0.95 (approximately)

In a similar manner, U can be calculated as:

U(Cat, New York)=1, since r(F∩V) for a combination of “Cat” and “New York” is less than r(F).

C will be the weighted average of I (Cat), I (New York) and U (Cat, New York). C can be calculated as:

C=[(200*1)+(100*0.95)+(10*1)]/[200+100+10]

C=0.98 (approximately)

After the values of I, U and C have been determined, user interface 203 displays these values to the user.

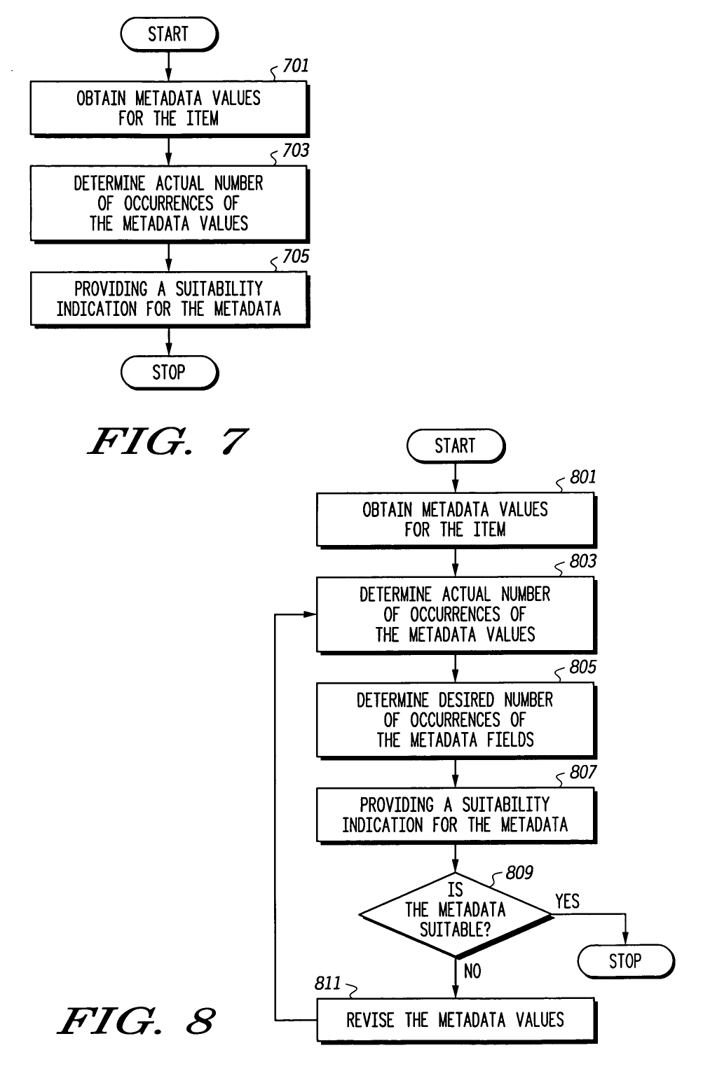

It may be noted that the suitability indication for the metadata values can also be provided on the basis of only the actual number of occurrences. This alternative embodiment of the present invention has been illustrated in FIG. 7. At step 701, the metadata values are obtained. These metadata values are either generated automatically or provided by a user. At step 703, metadata suitability evaluator 201 determines the actual number of occurrences for these metadata values. Thereafter at step 705, metadata suitability evaluator 201 provides a suitability indication based on the actual number of occurrences determined at step 703. There may be various approaches that provide suitability indication on the basis of only the actual number of occurrences. In one such approach, the actual number of occurrences for each metadata value may be compared with a predefined value. The predefined value may be different for different fields corresponding to the metadata values. For example, the system can have a predefined or default value of “70” for the “title” field and a value of “30” for the “artist” field. Assuming that actual number of occurrences for “title” field and “artist” field for an audio file are 100 and 20 respectively, the value 100 can be compared with 70 to provide I for the “title” field. Similarly, the value 30 can be compared with 20 to provide I for the “artist” field. The combined suitability for these fields may be calculated using the individual suitabilities as described in the preferred embodiment for the present invention.

The evaluation of metadata suitability may also be used for annotating an item with a suitable metadata. This embodiment of the present invention has been described hereinafter in conjunction with FIG. 8. Steps 801-807 are similar to the steps 301-307 (FIG. 3) of preferred embodiment of the present invention. These steps are carried out to evaluate the suitability of metadata values. In accordance with this embodiment, after the suitability evaluation results have been provided to the user, the user checks whether the metadata is suitable, as shown at step 809. If the user feels that the metadata is suitable, then the method for annotating the item with suitable metadata is completed. However, if the user feels that the metadata is unsuitable, then the user interface allows the user to revise the metadata values, as show at step 811; After the user has revised the metadata values, steps 803-807 are repeated to evaluate the suitability of the revised metadata values. If the revised metadata is also unsuitable, the user may revise the metadata values again. This process of revising the metadata values and their suitability evaluation may be repeated until the user feels that the metadata values are suitable. In case of automatic generation of metadata for the item, the metadata values may be revised automatically by the system.

In another embodiment of the present invention, the method and system for annotating an item with a suitable metadata also provides the relative importance of each metadata field to the user. The relative importance of a field indicates the importance of the field over other fields for the item. The relative importance of fields will suggest to the user, the fields that-he/she should preferably annotate. For example, consider an item that has 8 metadata fields associated with it. However, the user would not like to fill all these 8 fields. In such a case, the relative importance of fields will suggest 3-4 fields to the user that he/she should preferably annotate, based on his/her past searching habits. The relative importance of fields is provided to the user on the basis of frequency of previous searches, n(F). The fields that have been more frequently searched by the user hold more relevance to the user. Therefore, it is preferable that the user annotates these fields. In an exemplary manner, the fields may be shown to the user in decreasing order of importance. That is, the field with highest relative importance can be shown at the top of the user interface while the field with lowest relative importance can be shown at the bottom of the user interface. Alternatively, the user interface may hide some of the fields, which have importance less than a predefined threshold. However, after the relative importance of fields has been provided to the user, it is upon the discretion of the user to annotate them. The user may or may not annotate those fields depending upon his/her choice.

In yet another possible embodiment of the present invention, computer readable memory 101 stores the metadata and past searching habits of the users on a per user basis. It is quite possible that multiple users access a common collection of items. In such a case, the users would use different search criteria for retrieving an item from the database as they have different searching habits. For example, one user would like to search for a video by giving its title while another user would like to search by giving the artist's name. It is important that the method for evaluating the metadata for an item takes into consideration the past searching habits on a per user basis. In case of multiple users accessing a common collection of items, it is likely that different metadata is annotated to a single item. For example, one user may like to annotate an audio file by giving just the title (as he is more comfortable in searching with title) while another user would like to annotate it by giving the artist of the audio (as she is more comfortable in searching with artist). In such a scenario, a single item has multiple sets of metadata values. Therefore, for greater adaptability, computer readable memory 101 stores the metadata values and past searching habits of the users on a per user basis.

Hardware and Software Implementation

The system, as described in the present invention or any of its components, may be embodied in the form of a computer system. Typical examples of a computer system includes a general-purpose computer, a programmed microprocessor, a micro-controller, a peripheral integrated circuit element, and other devices or arrangements of devices that are capable of implementing the steps that constitute the method of the present invention.

The computer system executes a set of instructions that are stored in one or more storage elements, in order to process input data. The storage elements may also hold data or other information as desired. The storage element may be in the form of an information source or a physical memory element present in the processing machine.

The set of instructions may include various commands that instruct the processing machine to perform specific tasks such as the steps that constitute the method of the present invention. The set of instructions may be in the form of a software program. The software may be in various forms such as system software or application software. Further, the software might be in the form of a collection of separate programs, a program module with a larger program or a portion of a program module. The software might also include modular programming in the form of object-oriented programming. The processing of input data by the processing machine may be in response to user commands, or in response to results of previous processing or in response to a request made by another processing machine.

A person skilled in the art can appreciate that the various processing machines and/or storage elements may not be physically located in the same geographical location. The processing machines and/or storage elements may be located in geographically distinct locations and connected to each other to enable communication. Various communication technologies may be used to enable communication between the processing machines and/or storage elements. Such technologies include session of the processing machines and/or storage elements, in the form of a network. The network can be an intranet, an extranet, the Internet or any client server models that enable communication. Such communication technologies may use various protocols such as Transmission Control Protocol/Internet Protocol, User Datagram Protocol, Asynchronous Transfer Mode or Open System Interconnection.

While the preferred embodiments of the invention have been illustrated and described, it will be clear that the invention is not limited to these embodiments only. Numerous modifications, changes, variations, substitutions and equivalents will be-apparent to those skilled in the art without departing from the spirit and scope of the invention as described in the claims.

What is claimed is:

1. A method of evaluating suitability of metadata for an item, the item to be archived on a computer readable memory, the metadata for each item comprising a set of metadata values, the method comprising:
obtaining metadata values for the item;
searching the computer readable memory for items having associated metadata with at least one of the metadata values, the search being performed in order to determine actual number of occurrences of the metadata values; and
providing a suitability indication for the metadata, the suitability indication being based on a statistical analysis of the actual number of occurrences of the metadata values.

2. The method as recited in claim 1 wherein providing the suitability indication comprises displaying the suitability indication for the metadata values.

3. The method as recited in claim 1 wherein providing the suitability indication comprises providing an individual suitability for each metadata value for the item.

4. The method as recited in claim 1 wherein providing the suitability indication comprises providing a combined suitability for the metadata values.

5. The method as recited in claim 1 wherein providing the suitability indication comprises providing a union suitability for each valid combination of two or more metadata values.

6. A method of evaluating suitability of metadata for an item, the item to be archived on a computer readable memory, the metadata for each item comprising a set of fields and corresponding set of metadata values, the method comprising:
obtaining metadata values for the item;
searching the computer readable memory for items having associated metadata with at least one of the metadata values, the search being performed in order to determine actual number of occurrences of the metadata values;
obtaining desired number of occurrences for the metadata fields corresponding to the metadata values; and
providing a suitability indication for the metadata, the suitability indication being based on a statistical analysis of the actual number of occurrences of the metadata values and the desired number of occurrences for the metadata fields.

7. The method as recited in claim 6 wherein obtaining the desired number of occurrences for the metadata fields comprises:
identifying past successful searches performed on the fields corresponding to the metadata values by a user; and
determining the desired number of occurrences of the metadata fields, the desired number of occurrences being an average of number of search results returned by the past successful searches.

8. The method as recited in claim 7 wherein the past successful searches are identified using searches that were not cancelled by the user within a predefined time after the completion of the searches.

9. A method of annotating an item with a suitable metadata, the item to be archived on a computer readable memory, the metadata for each item comprising a set of fields and corresponding set of metadata values, the method comprising:
(i) obtaining metadata values for the item;
(ii) searching the computer readable memory for items having associated metadata with at least one of the metadata values, the search being performed in order to determine actual number of occurrences of the metadata values;
(iii) obtaining desired number of occurrences for the metadata fields corresponding to the metadata values;
(iv) providing a suitability indication for the metadata, the suitability indication being based on a statistical analysis of the actual number of occurrences for the metadata values and the desired number of occurrences for the metadata fields;
(v) revising the metadata values if the suitability indication indicates that metadata values are not suitable; and
(vi) repeating steps (ii) to (vi) when the metadata values have been revised.

10. The method as recited in claim 9 wherein the method further comprises providing a relative importance of each metadata field for the item, the relative importance indicating the importance of the metadata field over other metadata fields.

11. The method as recited in claim 10 wherein the relative importance of each metadata field is provided using frequency of searches performed on the metadata field by a user in the past.

12. A computer program product for use with a computer, the computer program product comprising a computer usable medium having a computer readable program code embodied therein for evaluating suitability of metadata for an item, the item to be archived on a computer readable memory, the metadata for each item comprising a set of fields and a corresponding set of metadata values, the computer program code performing the steps of:
obtaining metadata values for the item;
searching the computer readable memory for items having associated metadata with at least one of the metadata values, the search being performed in order to determine actual number of occurrences of the metadata values;
obtaining desired number of occurrences for the metadata fields corresponding to the metadata values; and
providing a suitability indication for the metadata, the suitability indication being based on a statistical analysis of the actual number of occurrences of the metadata values and the desired number of occurrences for the metadata fields.

13. The computer program product as recited in claim 12 wherein the computer program code for performing the step of providing the suitability indication comprises a computer program code for performing the step of displaying the suitability indication for the metadata values.

14. The computer program product as recited in claim 12 wherein the computer program code for performing the step of obtaining the desired number of occurrences for the metadata fields comprises a computer program code for performing the steps of:
identifying past successful searches performed on the fields corresponding to the metadata values by a user; and
determining the desired number of occurrences for the metadata fields, the desired number of occurrences being an average of number of search results returned by the past successful searches.

15. The computer program product as recited in claim 12 wherein the computer program code for performing the step of providing the suitability indication comprises a computer program code for performing the step of providing an individual suitability for each metadata value for the item.

16. The computer program product as recited in claim 12 wherein the computer program code for performing the step of providing the suitability indication comprises a computer program code for performing the step of providing a combined suitability for the metadata values.

17. The computer program product as recited in claim 12 wherein the computer program code for performing the step of providing the suitability indication comprises a computer program code for performing the step of providing a union suitability for each valid combination of two or more metadata values.
